(19) United States
(12) Patent Application Publication
(10) Pub. No.: US 2013/0196813 A1
(43) Pub. Date: Aug. 1, 2013

(54) TRANSMISSION

(71) Applicants: Shinji OITA, Toyota-shi (JP); Masaru MORISE, Nukata-gun (JP); Satoru KASUYA, Nishio-shi (JP); Nobukazu IKE, Kariya-shi (JP); Hiroshi KATOU, Kariya-shi (JP); Toru SOUDA, Okazaki-shi (JP); Masahiro OTAKE, Nishio-shi (JP)

(72) Inventors: Shinji OITA, Toyota-shi (JP); Masaru MORISE, Nukata-gun (JP); Satoru KASUYA, Nishio-shi (JP); Nobukazu IKE, Kariya-shi (JP); Hiroshi KATOU, Kariya-shi (JP); Toru SOUDA, Okazaki-shi (JP); Masahiro OTAKE, Nishio-shi (JP)

(21) Appl. No.: 13/754,218

(22) Filed: Jan. 30, 2013

(30) Foreign Application Priority Data
Jan. 30, 2012 (JP) 2012-017184

(51) Int. Cl. F16H 3/62

(52) U.S. Cl. CPC F16H 3/62
USPC 475/284; 475/269; 475/303; 475/275

(57) ABSTRACT

A transmission comprising at least four planetary gear sets and at least six coupling elements which are all disposed coaxially with each other, and an input rotary member which is disposed on one of opposite axial sides of the transmission and which receives an input rotary motion, the transmission having a plurality of speed positions which have respective different speed ratios and which are established by engaging actions of respective combinations of coupling elements selected from the at least six coupling elements and releasing actions of respective combinations of the other coupling elements selected from the at least six coupling elements, wherein an improvement includes: the at least six coupling elements including at least two input clutches which are all connected to the input rotary member and which are all disposed on one of opposite axial sides of the at least four planetary gear sets, which one side corresponds to the one of the opposite axial sides of the transmission.

### BACKGROUND OF THE INVENTION

1. Field of the Invention

The present invention relates in general to a transmission, and more particularly to improvements of a multiple-step transmission having at least four planetary gear sets and at least six coupling elements which are all disposed coaxially with each other.

2. Description of Related Art

There is proposed a transmission which has at least four planetary gear sets and at least six coupling elements that are all disposed coaxially with each other, and an input rotary member disposed at one axial end thereof to receive an input rotary motion, and in which the coupling elements are engaged and released in selected combinations to establish a plurality of speed positions having respective different speed ratios. Patent Documents 1 and 2 identified below disclose examples of such a transmission for a vehicle, which have nine and ten forward drive speed positions, respectively.

### PRIOR ART DOCUMENTS

Patent Document 1: JP-2011-513662 A
Patent Document 2: US-2009/0192009 A1

However, such a transmission having at least four planetary gear sets and at least six coupling elements that are all disposed coaxially with each other tends to be large-sized due to design restrictions of gear trains, and to suffer from a low degree of freedom of installation on a transverse FF (front-engine front-drive) vehicle, and is therefore required to be made as compact as possible in construction.

### SUMMARY OF THE INVENTION

The present invention was made in view of the background art described above. It is therefore an object of the present invention to provide a transmission which has at least four planetary gear sets and at least six coupling elements disposed coaxially with each other and which is highly compact in construction.

### Means for Achieving the Object

The object indicated above is achieved according to a first aspect of the present invention, which provides a transmission comprising at least four planetary gear sets and at least six coupling elements which are all disposed coaxially with each other, and an input rotary member which is disposed on one of opposite axial sides of the transmission and which receives an input rotary motion, the transmission having a plurality of speed positions which have respective different speed ratios and which are established by engaging actions of respective combinations of coupling elements selected from the above-described at least six coupling elements and releasing actions of respective combinations of the other coupling elements selected from the above-described at least six coupling elements, characterized in that the above-described at least six coupling elements include at least two input clutches which are all connected to the above-described input rotary member and which are all disposed on one of opposite axial sides of the above-described at least four planetary gear sets, which one side corresponds to the above-described one of the opposite axial sides of the transmission.

According to a first preferred form of the first aspect of the invention, the above-described at least six coupling elements include at least one brake which is disposed, together with the above-described at least two input clutches, on the above-described one of the opposite axial sides of the above-described at least four planetary gear sets.

According to a second preferred form of the first aspect of the invention, the above-described at least two input clutches have respective different diameters and are disposed radially outwardly and inwardly of each other so as to at least partially overlap each other in an axial direction.

The object indicated above is also achieved according to a second aspect of this invention, which provides a transmission comprising at least four planetary gear sets and at least six coupling elements which are all disposed coaxially with each other, and an input rotary member which is disposed on one of opposite axial sides of the transmission and which receives an input rotary motion, the transmission having a plurality of speed positions which have respective different speed ratios and which are established by engaging actions of respective combinations of coupling elements selected from the at least six coupling elements and releasing actions of respective combinations of the other coupling elements selected from the at least six coupling elements, characterized in that (a) the above-described at least six coupling elements include at least four clutches which are spaced from the above-described planetary gear sets in an axial direction of the transmission, and (b) the above-described at least four clutches include at least two sets of clutches each set consisting of at least two clutches which have respective different diameters and which are disposed radially outwardly and inwardly of each other so as to at least partially overlap each other in the axial direction.

According to a first preferred form of the first and second aspects of the invention, the above-described at least four planetary gear sets are all of a single-pinion type, and include at least two planetary gear sets which respectively have a ring gear and a sun gear disposed radially outwardly of the ring gear such that the ring gear and the sun gear at least partially overlap each other in an axial direction and such that the ring gear and the sun gear are rotated together as a unit. In this respect, an expression “rotated together as a unit” is interpreted to mean that the ring gear and the sun gear are integrally formed as a one-piece member, or fixed together, or alternatively splined or otherwise connected to each other such that the ring gear and the sun gear are rotated together.

According to a second preferred form of the first and second aspects of the invention, the transmission further comprises an output gear as an output rotary member, and wherein (a) the above-described at least six coupling elements include at least one dog-type coupling element which is released for only shift-up actions of the transmission, and (b) at least one of the above-described at least one dog-type coupling element is disposed radially inwardly of the output gear, so as to at least partially overlap the output gear in the axial direction. In this respect, an expression “dog-type coupling element” is interpreted to mean a meshing type coupling element, and comprehends a dog-type clutch or a dog-type brake. An expression “output gear” is interpreted to mean an output rotary member having external teeth which meshes with another gear, a chain or a toothed belt operatively connected to drive wheels of a vehicle.

According to a third preferred form of the first and second aspects of the invention, the above-described plurality of speed positions are established by releasing actions of respective combinations of two coupling elements selected from the above-described at least six coupling elements and engaging actions of respective combinations of the remaining coupling elements.

According to a fourth preferred form of the first and second aspects of the invention, the above-described plurality of speed positions consist of at least nine speed positions.

The object indicated above is also achieved according to a third aspect of this invention, which provides a transmission comprising four planetary gear sets and six coupling elements which are all disposed coaxially with each other, and an input rotary member which receives an input rotary motion, the transmission having a plurality of speed positions which have respective different speed ratios and which are established by engaging actions of respective combinations of coupling elements selected from the six coupling elements and releasing actions of respective combinations of the other coupling elements selected from the six coupling elements, characterized in that (a) the above-described four planetary gear sets consist of a first planetary gear set, a second planetary gear set, a third planetary gear set and a fourth planetary gear set, while the above-described six coupling elements consist of a first clutch, a second clutch, a third clutch, a fourth clutch, a first brake and a second brake, (b) the first planetary gear set and the second planetary gear set constitute a first transmission portion wherein the first and second planetary gear sets are connected to each other so as to provide four rotary elements consisting of a 1-1 rotary element, a 1-2 rotary element, a 1-3 rotary element and a 1-4 rotary element which are arranged in this order of description as seen in a collinear chart from one end toward the other end of one part of the collinear chart, and the 1-2 rotary element is selectively connected to the above-described input rotary member through the first clutch, while the 1-4 rotary element is selectively held stationary by the first brake, (c) the third planetary gear set constitutes a second transmission portion including three rotary elements consisting of a 2-1 rotary element, a 2-2 rotary element and a 2-3 rotary element which are arranged in this order of description as seen in a collinear chart from one end toward the other end of another part of the collinear chart, and wherein the 2-1 rotary element is selectively connected to the above-described input rotary member through the fourth clutch, and the 2-2 rotary element is selectively held stationary by the second brake, (d) the 1-1 rotary element of the above-described first transmission portion is selectively connected to the 2-2 rotary element of the above-described second transmission portion through the second clutch and to the 2-1 rotary element of the second transmission portion through the third clutch, and (e) the fourth planetary gear set constitutes a third transmission portion including three rotary elements consisting of a 3-1 rotary element, a 3-2 rotary element and a 3-3 rotary element which are arranged in this order of description as seen in the collinear chart from one end toward the other end of a collinear chart, and wherein the 3-1 rotary element is fixed to the 2-3 rotary element of the above-described second transmission portion, and the 3-3 rotary element is fixed to the 1-3 rotary element of the above-described first transmission portion, while the 3-2 rotary element is fixed to an output rotary member. In this respect, the “collinear chart” is a chart that shows respective rotational speeds of the rotary elements using straight lines. In the collinear chart, vertical axes corresponding to the respective rotary elements are positioned such that spaces between the vertical axes correspond to gear ratios ρ (i.e., teeth number of the sun gear/teeth number of the ring gear) of the planetary gear sets.

According to a first preferred form of the third aspect of the invention, the above-described first, second, third and fourth planetary gear sets are all of a single-pinion type.

According to a second preferred form of the third aspect of the invention, (a) the above-described first planetary gear set of the above-described first transmission portion is a planetary gear set of a single-pinion type having a sun gear S1, a carrier CA1 and a ring gear R1, and the above-described second planetary gear set of the first transmission portion is a planetary gear set of a single-pinion type having a sun gear S2, a carrier CA2 and a ring gear R2, the sun gear S2 constituting the above-described 1-1 rotary element, the ring gear R1 and the carrier CA2 are fixed to each other to constitute the above-described 1-2 rotary element, the carrier CA1 and the ring gear R2 are fixed to each other to constitute the above-described 1-3 rotary element, and the sun gear S1 constituting the above-described 1-4 rotary element, (b) the above-described third planetary gear set of the above-described second transmission portion is a planetary gear set of a single-pinion type having, as the three rotary elements, a sun gear S3, a carrier CA3 and a ring gear R3, the sun gear S3 constituting the above-described 2-1 rotary element, the carrier CA3 constituting the above-described 2-2 rotary element, and the ring gear R3 constituting the above-described 2-3 rotary element, (c) and the above-described fourth planetary gear set of the above-described third transmission portion is a planetary gear set of a single-pinion type having, as the three rotary elements, a sun gear S4, a carrier CA4 and a ring gear R4, the sun gear S4 constituting the above-described 3-1 rotary element, the carrier CA4 constituting the above-described 3-2 rotary element, and the ring gear R4 constituting the above-described 3-3 rotary element.

The object indicated above is also achieved according to a fourth aspect of this invention, which provides a transmission comprising four planetary gear sets and six coupling elements which are all disposed coaxially with each other, and an input rotary member which receives an input rotary motion, the transmission having a plurality of speed positions which have respective different speed ratios and which are established by engaging actions of respective combinations of coupling elements selected from the six coupling elements and releasing actions of respective combinations of the other coupling elements selected from the six coupling elements, characterized in that (a) the above-described four planetary gear sets consist of a first planetary gear set, a second planetary gear set, a third planetary gear set and a fourth planetary gear set, while the above-described six coupling elements consist of a first clutch, a second clutch, a third clutch, a fourth clutch, a first brake and a second brake, (b) the first planetary gear set is a planetary gear set of a single-pinion type having a sun gear S1, a carrier CA1 and a ring gear R1, and the second planetary gear set is a planetary gear set of a single-pinion type having a sun gear S2, a carrier CA2 and a ring gear R2, the first and second planetary gear sets constituting a first transmission portion wherein the sun gear S2 constitutes a 1-1 rotary element, the ring gear R1 and the carrier CA2 are fixed to each other to constitute a 1-2 rotary element, the carrier CA1 and the ring gear R2 are fixed to each other to constitute a 1-3 rotary element, and the sun gear S1 constitutes a 1-4 rotary element, the 1-2 rotary element being selectively connected to the above-described input rotary member through the first clutch, while the 1-4 rotary element is selectively held stationary by the first brake, (c) the third planetary gear set is a planetary gear set of a single-pinion type which has a sun gear S3, a carrier CA3 and a ring gear R3 and which constitutes a second transmission portion wherein the sun gear S3 constitutes a 2-1 rotary element, the carrier CA3 constitutes a 2-2 rotary element, and the ring gear R3 constitutes a 2-3 rotary element, the 2-1 rotary element being selectively connected to the above-described input rotary member through the fourth clutch, and the 2-2 rotary element being selectively held stationary by the second brake, (d) the 1-1 rotary element of the above-described first transmission portion is selectively connected to the 2-2 rotary element of the above-described second transmission portion through the second clutch and to the 2-1 rotary element of the second transmission portion through the third clutch, and (e) the fourth planetary gear set is a planetary gear set of a single-pinion type which has a sun gear S4, a carrier CA4 and a ring gear R4 and which constitutes a third transmission portion wherein the sun gear 54 constitutes a 3-1 rotary element, the carrier CA4 constitutes a 3-2 rotary element, and the ring gear R4 constitutes a 3-3 rotary element, the 3-1 rotary element being fixed to the 2-3 rotary element of the above-described second transmission portion, and the 3-3 rotary element is fixed to the 1-3 rotary element of the above-described first transmission portion, while the 3-2 rotary element is fixed to an output rotary member.

According to a first preferred form of the third and fourth aspects of this invention, the above-described input rotary member is disposed on one of opposite axial sides of the above-described four planetary gear sets, and the above-described first clutch and the above-described fourth clutch are disposed on the above-described one of the opposite axial sides of the above-described four planetary gear sets and are connected to the above-described input rotary member, the first and fourth clutches having respective different diameters and being disposed radially outwardly and inwardly of each other, so as to at least partially overlap each other in an axial direction.

According to a second preferred form of the third and fourth aspects of the invention, the above-described first, second and third planetary gear sets are arranged in the axial direction in this order of description, and the above-described second and third clutches have respective different diameters and are disposed between the above-described second and third planetary gear sets in the axial direction, and radially outwardly and inwardly of each other, so as to at least partially overlap each other in the axial direction.

According to a third preferred form of the third and fourth aspects of the invention, the above-described fourth planetary gear set is disposed radially outwardly of the above-described third planetary gear set, so as to at least partially overlap each other in the axial direction, such that the sun gear S4 of the fourth planetary gear set is disposed radially outwardly of the ring gear R3 of the third planetary gear set and such that the sun gear S4 and the ring gear R3 are rotated together as a unit.

According to a fourth preferred form of the third and fourth aspects of the invention, further comprising an output gear as an output rotary member, and wherein the above-described second brake is a dog-type brake disposed radially inwardly of the above-described output gear, so as to at least partially overlap the output gear in the axial direction.

According to a fifth preferred form of the third and fourth aspects of the invention, the above-described plurality of speed positions consist of at least nine speed positions which are established by releasing actions of respective combinations of two coupling elements selected from the above-described six coupling elements and engaging actions of respective combinations of the remaining four coupling elements.

According to an advantageous arrangement of the above-indicated yet further preferred form of the third and fourth aspects of the invention, the above-described at least nine speed positions consist of a first speed position having a highest speed ratio, a second speed position having a speed ratio lower than that of the first speed position, a third speed position having a speed ratio lower than that of the second speed position, a fourth speed position having a speed ratio lower than that of the third speed position, a fifth speed position having a speed ratio lower than that of the fourth speed position, a sixth speed position having a speed ratio lower than that of the fifth speed position, a seventh speed position having a speed ratio lower than that of the sixth speed position, an eighth speed position having a speed ratio lower than that of the seventh speed position, and a ninth speed position having a speed ratio lower than that of the eighth speed position, and wherein (a) the above-described first speed position is established by engaging actions of the above-described third and fourth clutches and the above-described first and second brakes, and releasing actions of the above-described first and second clutches, (b) the above-described second speed position is established by engaging actions of the above-described first and third clutches and the above-described first and second brakes and releasing actions of the above-described second and fourth clutches, (c) the above-described third speed position is established by engaging actions of the above-described first and fourth clutches and the above-described first and second brakes and releasing actions of the above-described second and third clutches, (d) the above-described fourth speed position is established by engaging actions of the above-described first, third and fourth clutches and the above-described second brake and releasing actions of the above-described second clutch and the above-described first brake, (e) the above-described fifth speed position is established by engaging actions of the above-described first, second and fourth clutches and the above-described second brake and releasing actions of the above-described third clutch and the above-described first brake, (f) the above-described sixth speed position is established by engaging actions of the above-described first, second and third clutches and the above-described second brake and releasing actions of the above-described fourth clutch and the above-described first brake, (g) the above-described seventh speed position is established by engaging actions of the above-described first, second, third and fourth clutches and releasing actions of the above-described first and second brakes, (h) the above-described eighth speed position is established by engaging actions of the above-described first, second and third clutches and the above-described first brake and releasing actions of the above-described fourth clutch and the above-described second brake, and (i) the above-described ninth speed position is established by engaging actions of the above-described first, second and fourth clutches and the above-described first brake and releasing actions of the above-described third clutch and the above-described second brake.

### Advantages of the Invention

In the transmission according to the first aspect of the invention, the at least six coupling elements include the at least two input clutches which are all connected to the input rotary member and which are all disposed on one of opposite axial sides of the at least four planetary gear sets, which one side corresponds to the above-described one of the opposite axial sides of the transmission, namely, which one side is closer to the input rotary member in an axial direction of the transmission. Accordingly, the transmission has a high degree of freedom of design of its gear trains, permitting at least two power input paths (e.g., two power input paths) extending in the axial direction, for example, and compact construction while permitting selective multiple-step shifting actions to at least nine forward drive speed positions. In addition, the provision of the at least two power input paths reduces frequency of a power transmitting operation of each power input path for selected ones of the speed positions, permitting shorter diametric dimensions of members of the input clutches required to ensure sufficient degrees of fatigue resistance and structural strength, than the required diametric dimensions where the input clutches were disposed in an axially intermediate position of the transmission, and further compact construction of the transmission. Where the input clutches have respective different diameters and are disposed outwardly and inwardly of each other such that the input clutches at least partially overlap each other in the axial direction, as in a second preferred form of the first aspect of this invention described below, the transmission can be made compact in construction with reduction of a required axial dimension. Generally, a clutch has a smaller diametric dimension than a brake. A multiple-disk clutch of a frictional coupling type has a comparatively large axial dimension corresponding to the number of its friction plates. In this respect, the at least two clutches disposed radially outwardly and inwardly of each other so as to at least partially overlap each other in the axial direction contribute to considerable reduction of the required axial dimension of the transmission.

In the transmission according to the first preferred form of the first aspect of the invention, the at least six coupling elements include at least one brake which is disposed, together with the above-described at least two input clutches, on one of the opposite axial sides of the at least four planetary gear sets, which one side is closer to the input rotary member. Accordingly, the transmission can be made further compact in construction. Where the at least one brake is disposed radially outwardly of the input clutches, so as to at least partially overlap the input clutches in the axial direction, in particular, the transmission can be made compact in construction with further reduction of the required axial dimension.

In the transmission according to the second aspect of the invention, the at least six coupling elements include the at least four clutches, and the above-described at least four clutches include at least two sets of clutches each set consisting of at least two clutches which have respective different diameters and which are disposed radially outwardly and inwardly of each other so as to at least partially overlap each other in the axial direction. Accordingly, the transmission can be made compact in construction with reduction of a required axial dimension. Generally, a clutch has a smaller diametric dimension than a brake. A multiple-disk clutch of a frictional coupling type has a comparatively large axial dimension corresponding to the number of its friction plates. In this respect, the at least two sets of clutches each set consisting of the at least two clutches disposed radially outwardly and inwardly of each other so as to at least partially overlap each other in the axial direction contribute to considerable reduction of the required axial dimension of the transmission.

In the transmission according to the first preferred form of the first and second aspects of the invention, the at least four planetary gear sets are all of a single-pinion type, so that the transmission can be made compact in construction with a smaller required diametric dimension, than where planetary gear sets of a double-pinion type are used. Further, the at least four planetary gear sets include the two planetary gear sets which respectively have the ring gear and the sun gear disposed radially outwardly of the ring gear such that the ring gear and the sun gear at least partially overlap each other in an axial direction and such that the ring gear and the sun gear are rotated together as a unit. Accordingly, the transmission can be made further compact in construction with reduction of the required axial dimension.

In the transmission according to the second preferred form of the first and second aspects of the invention, an output gear is provided as an output rotary member, and the at least six coupling elements include at least one dog-type coupling element. At least one of the at least one dog-type coupling element is disposed radially inwardly of the output gear, so as to at least partially overlap the output gear in the axial direction. Accordingly, the transmission can be made compact in construction with reduction of the required axial dimension. Namely, the dog-type coupling element is arranged to transmit power by a meshing action of teeth, and has a sufficient torque capacity with a relatively small diameter, so that the dog-type coupling element can be disposed compactly and radially inwardly of the output gear. Further, the dog-type coupling element is advantageously free from a dragging power loss in a released state, contributing to an improvement in the fuel economy of the vehicle.

In the transmission according to the third preferred form of the first and second aspects of the invention, the plurality of speed positions are established by releasing actions of respective combinations of two coupling elements selected from the at least six coupling elements and engaging actions of respective combinations of all the remaining coupling elements. Accordingly, only one or two of the coupling elements suffer(s) from a dragging power loss during shifting actions of the transmission to the selected speed position, providing an improvement in the fuel economy of the vehicle.

In the transmissions according to the third and fourth aspects of the present invention, gear ratios ρ of the four planetary gear sets are suitably determined or selected within a range of about 0.25-0.6, for example, so that speed ratios of at least nine speed positions can be set to provide well balanced stepping ratios while the planetary gear sets are configured to be small-sized (in diameter) and compact in construction. Further, the first and fourth clutches functioning as the two input clutches can both be disposed adjacent to the input rotary member in the axial direction, so that the transmission has a high degree of freedom of design of the gear trains, permitting two power input paths extending in the axial direction, for example, and compact construction while permitting selective multiple-step shifting actions to the at least nine forward drive speed positions. In addition, the provision of the two power input paths reduces frequency of a power transmitting operation of each power input path for selected ones of the speed positions, permitting shorter diametric dimensions of members of the first and fourth clutches required to ensure sufficient degrees of fatigue resistance and structural strength, and further compact construction of the transmission. Further, the first and fourth clutches may have respective different diameters and may be disposed outwardly and inwardly of each other such that the first and fourth clutches at least partially overlap each other in the axial direction, as the first desired form of the third and fourth aspects of this invention described above, so that the transmission can be made compact in construction with a reduced axial dimension. Generally, a clutch has a smaller diametric dimension than a brake. A multiple-disk clutch of a frictional coupling type has a comparatively large axial dimension corresponding to the number of its friction plates. In this respect, the two clutches (first and fourth clutches) disposed radially outwardly and inwardly of each other so as to at least partially overlap each other in the axial direction contribute to considerable reduction of the required axial dimension of the transmission.

In the transmission according to the fourth aspect of the invention, the four planetary gear sets are all of a single-pinion type, so that the transmission can be made compact in construction with a smaller required diametric dimension, than where planetary gear sets of a double-pinion type are used. These advantages apply to the transmission according to the first and second preferred forms of the third aspect of the invention.

In the transmission according to the second desired form of the third and fourth aspects of the invention, the above-described second and third clutches have respective different diameters and are disposed between the above-described second and third planetary gear sets in the axial direction, and radially outwardly and inwardly of each other, so as to at least partially overlap each other in the axial direction. Accordingly, the transmission can be made compact in construction with reduction of the required axial dimension.

In the transmission according to the third desired form of the third and fourth aspects of the invention, the fourth planetary gear set is disposed radially outwardly of the third planetary gear set, so as to at least partially overlap each other in the axial direction, such that the sun gear S4 of the fourth planetary gear set is disposed radially outwardly of the ring gear R3 of the third planetary gear set and such that the sun gear S4 and the ring gear R3 are rotated together as a unit. Accordingly, the transmission can be made compact with reduction of the required axial dimension.

In the transmission according to the fourth desired form of the third and fourth aspects of the invention, the above-described second brake is a dog-type brake disposed radially inwardly of the above-described output gear, so as to at least partially overlap the output gear in the axial direction. Accordingly, the transmission can be made compact in construction with reduction of the required axial dimension. The dog-type brake is arranged to transmit power by a meshing action of teeth, and has a sufficient torque capacity with a relatively small diametric dimension, so that the dog-type brake can be disposed compactly and radially inwardly of the output gear. Further, the dog-type brake is advantageously free from a dragging power loss, contributing to an improvement in the fuel economy of the vehicle.

In the transmission according to the fifth desired form of the third and fourth aspects of the invention, the above-described plurality of speed positions consist of at least nine speed positions which are established by releasing actions of respective combinations of two coupling elements selected from the above-described six coupling elements and engaging actions of respective combinations of the remaining four coupling elements. Accordingly, only one or two of the coupling elements suffer(s) from a dragging power loss during shifting actions of the transmission to the selected speed position, providing an improvement in the fuel economy of the vehicle.

In the transmission according to the advantageous arrangement of the fifth desired form of the third and fourth aspects of the invention, the gear ratios ρ of the four planetary gear sets are suitably determined or selected within a range of about 0.25-0.6, for example, so that speed ratios of the nine speed positions can be set to provide well balanced stepping ratios while the planetary gear sets are configured to be small-sized (in diameter) and compact in construction.

### BRIEF DESCRIPTION OF THE DRAWINGS

FIG. 1 is a schematic view showing an arrangement of major elements of a vehicular transmission constructed according to one embodiment of the present invention;

FIG. 2 a collinear chart indicating rotating speeds of various rotary elements in a plurality of speed positions of the transmission of FIG. 1, wherein positions of the rotating speeds are connectable by straight lines;

FIG. 3 is a table indicating a relationship between the plurality of speed positions of the transmission of FIG. 1, and different combinations of coupling elements placed in engaged states to establish the respective speed positions;

FIG. 4 is a cross sectional view specifically showing a positional relationship between a first clutch C1 and a fourth clutch C4 provided in the transmission of FIG. 1;

FIG. 5 is a schematic view showing a transmission according to another embodiment of this invention;

FIG. 6 is a schematic view showing a transmission according to a further embodiment of this invention; and

FIG. 7 is a schematic view showing a transmission according to a still further embodiment of the invention.

### DETAILED DESCRIPTION OF THE EMBODIMENTS

The present invention is suitably applicable to a transmission of a vehicle, and particularly to a transmission of a transverse FF (front-engine front-drive) vehicle in which the transmission is installed with its axis extending in the transverse or lateral direction of the vehicle. The transmission may be automatically shifted to a selected one of its speed positions according to a running condition of the vehicle as represented by an operating amount of an accelerator pedal and a running speed of the vehicle, for instance, or manually shifted to one of the speed positions selected according to manual shift-up and shift-down operations of a control switch or any other member by an operator of the vehicle.

All of the at least four planetary gear sets described above may be of a single-pinion type. However, some or all of the planetary gear sets may be of a double-pinion type. The at least six coupling elements described above are preferably constituted by hydraulically operated multiple-disk or single-disk belt-type frictional coupling devices (such as clutches and brakes) which are frictionally engaged by hydraulic cylinders, but may be electromagnetic or any other types of frictional coupling elements. The coupling elements may include a meshing dog-type brake or clutch under a particular shifting condition. A one-way clutch or clutches may be disposed in parallel or series with the above-indicated coupling elements, for facilitating the shifting actions of the transmission. The multiple-disk type coupling elements (clutches and brakes) have at least three friction plates which undergo frictional engagement on at least two friction surfaces, and generally tend to have a relatively large axial dimension. In this respect, two or more of the multiple-disk type coupling elements are preferably disposed radially outwardly and inwardly of each other so as to partially overlap each other in the axial direction, for significant reduction of the required axial dimension of the transmission.

The input rotary member described above is arranged to receive an input rotary motion from a vehicle drive power source, for example. The vehicle drive power source preferably includes an engine operable to generate power by combustion of a fuel. However, an electric motor or any other type of drive power source may be used in place of, or in addition to the engine.

The transmission according to the first aspect of this invention described above may be provided with two input clutches, or three or more input clutches, which are all disposed in one of the opposite end portions of the transmission which is closer to the input rotary member. The brake provided in the first preferred form of the first aspect of the invention described above is preferably constituted by a multiple-disk brake having at least three friction plates. However, the multiple-disk brake may be replaced by a belt-type brake, or a dog-type brake suitably used under a particular shifting condition. This brake preferably has a larger diameter than the input clutches and is preferably disposed radially outwardly of the input clutches so as to at least partially overlap the input clutches in the axial direction. In the transmission according to the above-described third or fourth aspect of this invention, too, one of the first and second brakes may be disposed together with the first and fourth clutches, adjacent to the input rotary member.

In the transmission according to the second preferred form of the first aspect of the invention described above, the at least two input clutches have respective different diameters and are disposed radially inwardly and outwardly of each other, so as to at least partially overlap each other in the axial direction. The overlapping positioning of the multiple-disk type input clutches, for example, means that an axial range of arrangement of the friction plates of one of the input clutches overlaps that of another input clutches. Although the at least partial overlapping positioning of the input clutches is desired, the partial overlapping positioning is not essential, namely, the input clutches may be disposed adjacent to each other in the axial direction so that the required axial dimension of the transmission can be made smaller than where the input clutches having almost the same diameters are juxtaposed or disposed side by side in the axial direction. This applies to a plurality of clutches having respective different diameters and disposed radially outwardly and inwardly of each other, and a plurality of planetary gear sets disposed radially outwardly and inwardly of each other, according to the other forms of the invention.

The transmission according to the second aspect of this invention described above is provided with at least four clutches including at least two sets of clutches each consisting of at least two clutches which have respective different diameters and which are disposed radially outwardly and inwardly of each other. However, the at least four clutches need not include at least two input clutches which are disposed on one of the opposite axial sides of the four planetary gear sets, which one side is closer to the input rotary member. In the transmission according to the second aspect of the invention, the four clutches are preferably disposed such that at least one of the four clutches is spaced apart from the other clutch or clutches by one or more of the plurality of planetary gear sets in the axial direction. However, all of the four clutches may be disposed on the same side of one of the planetary gear sets, if possible.

In the transmissions according to the above-described third and fourth aspects of the invention, too, the first and fourth clutches functioning as the input clutches are preferably disposed on the side of the input rotary member, and preferably have respective different diameters and are preferably disposed radially inwardly and outwardly of each other so as to at least partially overlap each other in the axial direction. However, these arrangements of the first and fourth clutches are not essential. That is, at least one of the first and fourth clutches may be disposed between the adjacent ones of the four planetary gear sets, or the first and fourth clutches may have substantially the same diameter and may be juxtaposed or disposed side by side in the axial direction. Further, the second and third clutches are both preferably disposed between the third and fourth planetary gear sets, or preferably have respective different diameters and are preferably disposed radially outwardly and inwardly of each other so as to at least partially overlap each other in the axial direction. However, the second and third clutches may have substantially the same diameter and may be juxtaposed or disposed side by side in the axial direction, or may be disposed at respective different axial positions.

### Embodiment 1

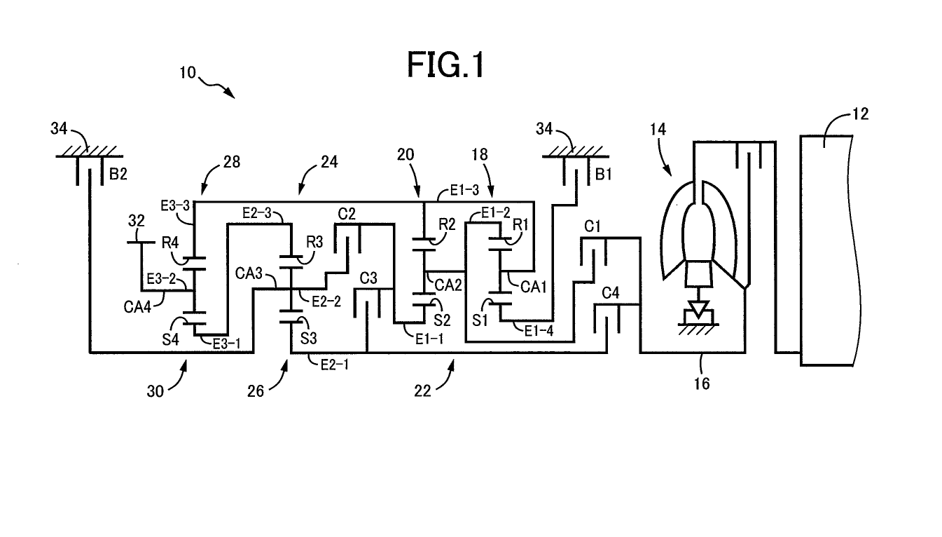

Embodiments of the present invention will be described in detail by reference to the drawings. Referring first to the schematic view of FIG. 1, there is shown an arrangement of major elements of a vehicular transmission 10 constructed according to a first embodiment of the present invention. As shown in FIG. 1, the transmission 10 includes: a fluid-type power transmitting device in the form of a torque converter 14 provided with a lock-up clutch; an input rotary member of the transmission 10 in the form of a turbine shaft 16 which is an output shaft of the torque converter 14; a first transmission portion 22 constituted principally by a first planetary gear set 18 and a second planetary gear set 20; a second transmission portion 26 constituted principally by a third planetary gear set 24; a third transmission portion 30 constituted principally by a fourth planetary gear set 28; and an output rotary member in the form of an output gear 32. The torque converter 14, turbine shaft 16, first, second and third transmission portions 22, 26, 30, and output gear 32 are all disposed coaxially with each other on a common axis in a transmission casing 34 (hereinafter referred to simply as “casing 34”), in the order of description. This transmission 10 is suitably used for a transverse FF vehicle (front-engine, front-drive vehicle) in which the transmission 10 is installed with its axis extending in the transverse or lateral direction of the vehicle. The transmission 10 is disposed between a vehicle drive power source in the form of an engine 12, and right and left drive wheels (not shown) and transmits an output of the engine 12 to the drive wheels. The output gear 32 meshes with a ring gear of a differential gear device (not shown), for instance, so that the right and left drive wheels are rotated through the differential gear device. It is noted that a lower half of the transmission 10, which is constructed symmetrically with respect to its axis, is omitted in the schematic view of FIG. 1.

The first planetary gear set 18 of the first transmission portion 22 is a planetary gear device of a single-pinion type which includes a sun gear S1, a carrier CA1, and a ring gear R1 and in which a pinion gear meshing with the sun gear S1 and the ring gear R1 is rotatably supported by the carrier CA1. The second planetary gear set 20 of the first transmission portion 22 is a planetary gear device of a single-pinion type which includes a sun gear S2, a carrier CA2, and a ring gear R2 and in which a pinion gear meshing with the sun gear S2 and the ring gear R2 is rotatably supported by the carrier CA2. The sun gear S2 constitutes a 1-1 rotary element E1-1, while the ring gear R1 and the carrier CA2 which are integrally fixed to each other so as to be rotatable together as a unit constitute as a 1-2 rotary element E1-2. The carrier CA1 and the ring gear R2 which are integrally fixed to each other so as to be rotatable together as a unit constitute a 1-3 rotary element E1-3, while the sun gear S1 constitutes a 1-4 rotary element E1-4. The 1-2 rotary element E1-2 (ring gear R1 and carrier CA2) is selectively connected to the turbine shaft 16 through a first clutch C1, while the 1-4 rotary element E1-4 (sun gear S1) is selectively fixed to the casing 34 through a first brake B1 so that the 1-4 rotary element E1-4 is selectively held stationary. The first clutch C1 functions as an input clutch.

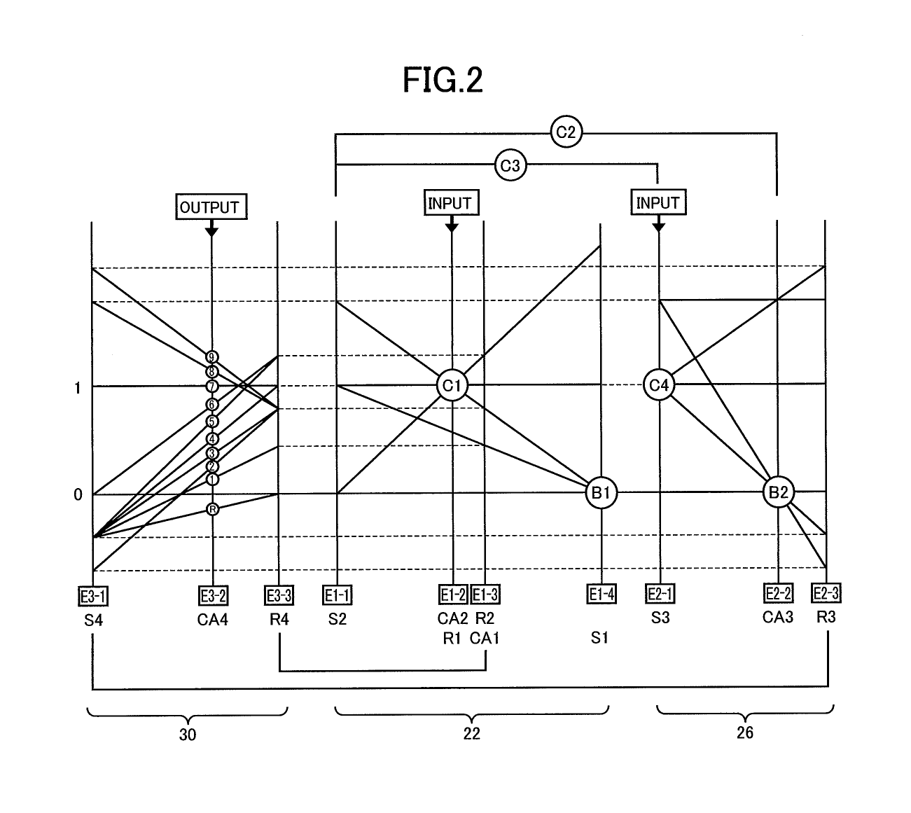

A central part of the collinear chart of FIG. 2 relates to the first transmission portion 22. Four vertical axes respectively represent the 1-1 rotary element E1-1, 1-2 rotary element E1-2, 1-3 rotary element E1-3 and 1-4 rotary element E1-4, in the order of description as seen in the rightward direction. Positions of rotating speeds of the rotary elements are connectable by straight lines. Distances between adjacent ones of the vertical axes representing the rotary elements are determined by a gear ratio ρ1 of the first planetary gear set 18 and a gear ratio ρ2 of the second planetary gear set 20. Described more specifically, a ratio of the distance between the axes of the 1-1 and 1-2 rotary elements E1-1 and E1-2 to the distance between the axes of the 1-2 and 1-3 rotary elements E1-2 and E1-3 is 1:ρ1, while a ratio of the distance between the axes of the 1-4 and 1-3 rotary elements E1-4 and E1-3 to the distance between the axes of the 1-3 and 1-2 rotary elements E1-3 and E1-2 is 1:ρ2. It is noted that a horizontal axis indicated by “0” represents the rotating speed of 0, i.e. a halt of rotation, while a horizontal axis indicated by “1” represents an input rotating speed, that is, the rotating speed of the turbine shaft 16.

The third planetary gear set 24 of the second transmission portion 26 is a planetary gear device of a single-pinion type which includes a sun gear S3, a carrier CA3, and a ring gear R3 and in which a pinion gear meshing with the sun gear S3 and the ring gear R3 is rotatably supported by the carrier CA3. The sun gear S3 constitutes a 2-1 rotary element E2-1, and the carrier CA3 constitutes a 2-2 rotary element E2-2, while the ring gear R3 constitutes a 2-3 rotary element E2-3. The 2-1 rotary element E2-1 (sun gear S3) is selectively connected to the turbine shaft 16 through a fourth clutch C4, while the 2-2 rotary element E2-2 (carrier CA3) is selectively fixed to the casing 34 through a second brake B2 so that the 2-2 rotary element E2-2 is selectively held stationary. The fourth clutch C4 functions as another input clutch.

A right part of the collinear chart of FIG. 2 relates to the second transmission portion 26. Three vertical axes respectively represent the 2-1 rotary element E2-1, 2-2 rotary element E2-2 and 2-3 rotary element E2-3, in the order of description as seen in the rightward direction. Positions of rotating speeds of these rotary elements are connectable by straight lines. Distances between adjacent ones of the vertical axes representing the rotary elements are determined by a gear ratio ρ3 of the third planetary gear set 24. Described more specifically, a ratio of the distance between the axes of the 2-1 and 2-2 rotary elements E2-1 and E2-2 to the distance between the axes of the 2-2 and 2-3 rotary elements E2-2 and E2-3 is 1:ρ3.

Between the first transmission portion 22 and the second transmission portion 26, there are disposed a second clutch C2 and a third clutch C3. The second clutch C2 selectively connects the 1-1 rotary element E1-1 (sun gear S2) of the first transmission portion 22 and the 2-2 rotary element E2-2 (carrier CA3) of the second transmission portion 26 to each other. The third clutch C3 selectively connects the 1-1 rotary element E1-1 (sun gear S2) of the first transmission portion 22 and the 2-1 rotary element E2-1 (sun gear S3) of the second transmission portion 26 to each other.

The fourth planetary gear set 28 of the third transmission portion 30 is a planetary gear device of a single-pinion type which includes a sun gear S4, a carrier CA4, and a ring gear R4 and in which a pinion gear meshing with the sun gear S4 and the ring gear R4 is rotatably supported by the carrier CA4. The sun gear S4 constitutes a 3-1 rotary element E3-1, and the carrier CA4 constitutes a 3-2 rotary element E3-2, while the ring gear R4 constitutes a 3-3 rotary element E3-3. The 3-1 rotary element E3-1 (sun gear S4) is integrally fixed to the 2-3 rotary element E2-3 (ring gear R3) of the second transmission portion 26 so as to be rotatable together as a unit, and the 3-3 rotary element E3-3 (ring gear R4) is integrally fixed to the 1-3 rotary element E1-3 (carrier CA1 and ring gear R2) of the first transmission portion 22 so as to be rotatable together as a unit, while the 3-2 rotary element E3-2 (carrier CA4) is integrally fixed to the output gear 32 so as to be rotatable together as a unit.

A left part of the collinear chart of FIG. 2 relates to the third transmission portion 30. Three vertical axes respectively represent the 3-1 rotary element E3-1, 3-2 rotary element E3-2 and 3-3 rotary element E3-3, in the order of description as seen in the rightward direction. Positions of rotating speeds of these rotary elements are connectable by straight lines. Distances between adjacent ones of the vertical axes representing the rotary elements are determined by a gear ratio ρ4 of the fourth planetary gear set 28. Described more specifically, a ratio of the distance between the axes of the 3-1 and 3-2 rotary elements E3-1 and E3-2 to the distance between the axes of the 3-2 and 3-3 rotary elements E3-2 and E3-3 is 1:ρ4.

The transmission 10 according to the present first embodiment includes the four planetary gear devices consisting of the first, second, third and fourth planetary gear sets 18, 20, 24 and 28 of the single-pinion type. Further, the transmission 10 includes the six coupling elements consisting of the first, second, third and fourth clutches C1, C2, C3 and C4, and the first and second brakes B1 and B2. These six coupling elements are hydraulically operated frictional coupling multiple-disk clutches and brakes.

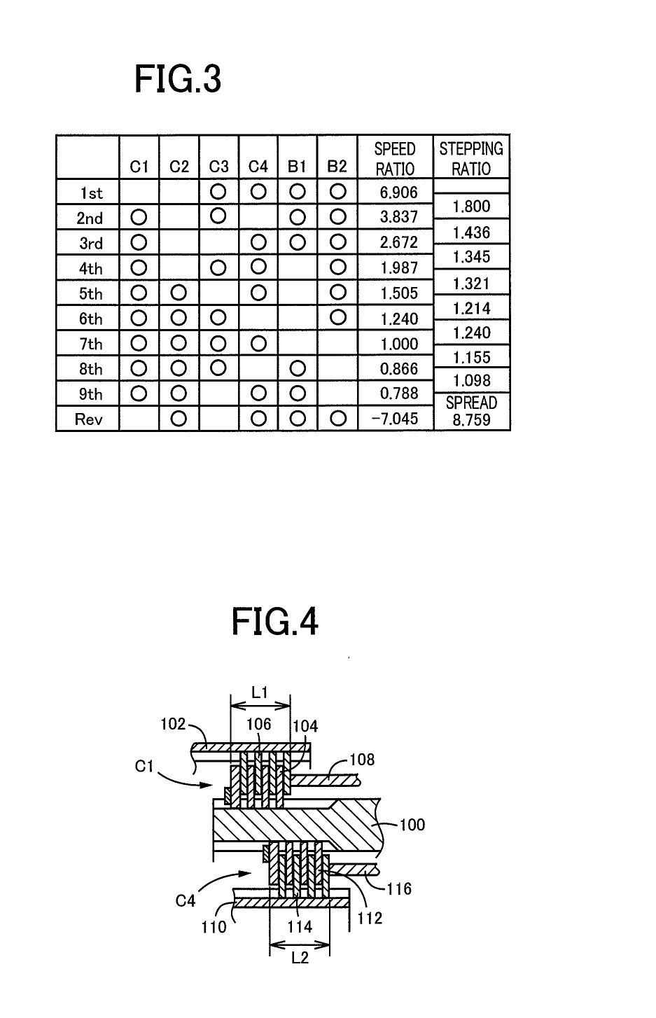

The transmission 10 has nine forward drive speed positions, namely, a first speed position “1st” to a ninth speed position “9th”, and one reverse drive position “Rev”, which are established by releasing actions of respective combinations of two coupling elements selected from the above-described six coupling elements C1-C4, B1, and B2 and engaging actions of respective combinations of the remaining four coupling elements, as indicated in the table of FIG. 3. In the collinear chart of FIG. 2, numerals “1-9” enclosed within circles, labeled along a vertical axis representing the 3-2 rotary element E3-2, represent the nine forward drive positions “1st” through “9th”, while a letter “R” enclosed within a circle represents the reverse drive position “Rev”. As is apparent from the collinear chart of FIG. 2, the rotating speeds of the two input rotary elements of the third transmission portion 30 in the form of the 3-3 and 3-1 rotary elements E3-3 and E3-1 are respectively determined by the first and second transmission portions 22 and 26, to determine the rotating speed of the output rotary element in the form of the 3-2 rotary element E3-2. Described more specifically, the rotating speed of the 3-3 rotary element E3-3 is determined by the 1-3 rotary element E1-3 of the first transmission portion 22 while the rotating speed of the 3-1 rotary element E3-1 is determined by the 2-3 rotary element E2-3 of the second transmission portion 26, so that the rotating speed of the 3-2 rotary element E3-2 is determined.

Each of the forward drive speed positions and reverse drive position of the transmission 10 described above will be described in detail. The first speed position “1st” having the highest speed ratio (rotating speed of the turbine shaft 16/rotating speed of the output gear 32) is established by engaging actions of the third clutch C3, fourth clutch C4, first brake B1 and second brake B2 and releasing actions of the first clutch C1 and second clutch C2. The second speed position “2nd” having a speed ratio lower than that of the first speed position “1st” is established by engaging actions of the first clutch C1, third clutch C3, first brake B1 and second brake B2 and releasing actions of the second clutch C2 and fourth clutch C4. The third speed position “3rd” having a speed ratio lower than that of the second speed position “2nd” is established by engaging actions of the first clutch C1, fourth clutch C4, first brake B1 and second brake B2 and releasing actions of the second clutch C2 and third clutch C3. The fourth speed position “4th” having a speed ratio lower than that of the third speed position “3rd” is established by engaging actions of the first clutch C1, third clutch C3, fourth clutch C4 and second brake B2 and releasing actions of the second clutch C2 and first brake B1. The fifth speed position “5th” having a speed ratio lower than that of the fourth speed position “4th” is established by engaging actions of the first clutch C1, second clutch C2, fourth clutch C4 and second brake B2 and releasing actions of the third clutch C3 and first brake B1. The sixth speed position “6th” having a speed ratio lower than that of the fifth speed position “5th” is established by engaging actions of the first clutch C1, second clutch C2, third clutch C3, and second brake B2 and releasing actions of the fourth clutch C4 and first brake B1. The seventh speed position “7th” having a speed ratio lower than that of the sixth speed position “6th” is established by engaging actions of the first clutch C1, second clutch C2, third clutch C3 and fourth clutch C4 and releasing actions of the first brake B1 and second brake B2. This seventh speed position “7th” in which the transmission 10 is integrally operated has the speed ratio of “1”. Namely, the rotating speed of the output rotary member in the form of the output gear 32 is equal to that of the input rotary member in the form of the turbine shaft 16. The eighth speed position “8th” having a speed ratio lower than that of the seventh speed position “7th” is established by engaging actions of the first clutch C1, second clutch C2, third clutch C3 and first brake B1 and releasing actions of the fourth clutch C4 and second brake B2. The ninth speed position “9th” having a speed ratio lower than that of the eighth speed position “8th” is established by engaging actions of the first clutch C1, second clutch C2, fourth clutch C4 and first brake B1 and releasing actions of the third clutch C3 and second brake B2. Further, the reverse drive position “Rev” is established by engaging actions of the second clutch C2, fourth clutch C4, first brake B1 and second brake B2 and releasing actions of the first clutch C1 and third clutch C3.

In the transmission 10 configured as described above, the gear ratios ρ1-ρ4 of the first, second, third and fourth planetary gear sets 18, 20, 24, 28 are suitably determined or selected within a range of about 0.25-0.6, so that the speed ratios of the forward drive positions “1st” through “9th” can be set to provide well balanced stepping ratios while the planetary gear sets 18, 20, 24, 28 are configured to be small-sized (in diameter) and compact in construction. The table of FIG. 3 indicates an example of a set of the speed ratios of the forward drive positions “1st” to “9th” and the reverse drive position “Rev” where the gear ratios ρ1-ρ4 of the first, second, third and fourth planetary gear sets 18, 20, 24, 28 are respectively determined to be about 0.25, about 0.25, about 0.40 and about 0.55. In this specific example, the speed ratio of the ninth speed position “9th” is set to be 0.788, to give this speed position a high gear ratio, and an overall spread of the speed ratios is as broad as 8.759, permitting the transmission 10 to have a totally adequate speed ratio arrangement.

The transmission 10 according to the present invention is further configured such that two clutches which consist of the first clutch C1 and the fourth clutch C4 and function as the input clutches are disposed on one of the opposite axial sides of the transmission 10, that is, on one of the opposite axial sides of the four planetary gear sets 18, 20, 24, 28, which one side is closer to the turbine shaft 16 in the axial direction (in the right and left direction as seen in FIG. 1). These two clutches C1, C4, which have different diameters, are disposed such that the first clutch C1 is located radially outwardly of the fourth clutch C4, as specifically shown in the cross sectional view of FIG. 4. The first clutch C1 is disposed radially outwardly of a cylindrical input drum 100 rotated together with the turbine shaft 16, while the fourth clutch C4 is disposed radially inwardly of the input drum 100. A connecting drum 102 having a larger diameter than the input drum 100 is mounted on the 1-2 rotary element E1-2 (ring gear R1 and carrier CA2) of the first transmission portion 22, which is connected to the turbine shaft 16 through the first clutch C1. In an annular space between the input drum 100 and the connecting drum 102, there are disposed a plurality of radially outward friction plates 104 splined to the input drum 100, and a plurality of radially inward friction plates 106 splined to the connecting drum 102, such that the radially outward friction plates 104 and the radially inward friction plates 106 are alternately arranged in the axial direction, and are axially pressed against each other by a hydraulically operated presser member 108, for frictional contact with each other to connect the input drum 100 and the connecting drum 102 to each other such that the input and connecting drums 100, 102 are rotated together, to thereby connect the 1-2 rotary element E1-2 to the turbine shaft 16. The first clutch C1 includes the radially inward and outward friction plates 104, 106 and the presser member 108.

A connecting drum 110 having a smaller diameter than the input drum 100 is mounted on the 2-1 rotary element E2-1 (sun gear S3) of the second transmission portion 26, which is connected to the turbine shaft 16 through the fourth clutch C4. In an annular space between the input drum 100 and the connecting drum 110, there are disposed a plurality of radially outward friction plates 112 splined to the input drum 100, and a plurality of radially inward friction plates 114 splined to the connecting drum 110, such that the radially outward friction plates 112 and the radially inward friction plates 114 are alternately arranged in the axial direction, and are axially pressed against each other by a hydraulically operated presser member 116, for frictional contact with each other to connect the input drum 100 and the connecting drum 110 to each other such that the input and connecting drums 100, 110 are rotated together, to thereby connect the 2-1 rotary element E2-1 to the turbine shaft 16. The fourth clutch C4 includes the radially inward and outward friction plates 112, 114 and the presser member 116.

In the present embodiment, the first clutch C1 is disposed radially outwardly of the fourth clutch C4 such that an axial range L1 of arrangement of the friction plates 104, 106 of the first clutch C1 and an axial range L2 of arrangement of the friction plates 112, 114 of the fourth clutch C4 at least partially overlap each other in the axial direction, so that the required axial dimension of the transmission 10 can be reduced.

Further, the first brake B1 as well as the first and fourth clutches C1 and C4 is disposed on one of the opposite sides of the four planetary gear sets 18, 20, 24, 28, which one side is closer to the turbine shaft 16 in the axial direction, and such that the first brake B1 having a larger diameter than the first clutch C1 is disposed radially outwardly of the first clutch C1, so as to at least partially overlap the first clutch C1 in the axial direction. Described more specifically, like the first clutch C1 disposed radially outwardly of the fourth clutch C4, the first brake B1 is disposed radially outwardly of at least one of the first and fourth clutches C1, C4, namely, radially outwardly of the first clutch C1 disposed radially outwardly of the fourth clutch C4, such that the first brake B1 and the first clutch C1 at least partially overlap each other in the axial direction, so that the required axial dimension of the transmission 10 can be further reduced, and the transmission 10 can be made compact in construction.

In addition, the second clutch C2 and the third clutch C3 are disposed between the second planetary gear set 20 and the third planetary gear set 24 in the axial direction, and have different diameters, with the second clutch C2 being disposed radially outwardly of the third clutch C3. Like the first clutch C1 disposed radially outward of the fourth clutch C4, the second clutch C2 is disposed radially outwardly of the third clutch C3 such that the second and third clutches C2 and C3 at least partially overlap each other in the axial direction, so that the required axial dimension of the transmission 10 can be further reduced, and the transmission 10 can be made further compact in construction.

As described above, the transmission 10 according to the present embodiment is configured such that the gear ratios p1-p4 of the first, second, third and fourth planetary gear sets 18, 20, 24, 28 are suitably determined or selected within the range of about 0.25-0.6, so that the speed ratios of the forward drive speed positions “1st” through “9th” can be set to provide well balanced stepping ratios while the planetary gear sets 18, 20, 24, 28 are configured to be small-sized (in diameter) and compact in construction. Further, the speed ratio of the ninth speed position “9th” is set to be 0.788, to give this speed position a high gear ratio, and the overall spread of the speed ratios is as broad as 8.759, permitting the transmission 10 to have a totally adequate speed ratio arrangement.

Further, since the first and fourth clutches C1, C4 functioning as the two input clutches are both disposed together at a distal end of the axial direction, i.e., adjacent to the turbine shaft 16 in the axial direction, the transmission 10 has a high degree of freedom of design of the gear trains, permitting two power input paths extending in the axial direction, for example, and compact construction while permitting selective multiple-step shifting actions to the nine forward drive speed positions. In addition, the provision of the two power input paths reduces frequency of a power transmitting operation of each power input path for selected ones of the speed positions, permitting shorter diametric dimensions of members of the first and fourth clutches C1, C4 required to ensure sufficient degrees of fatigue resistance and structural strength, than the required diametric dimensions where the clutches C1, C4 were disposed in an axially intermediate position of the transmission 10, and further compact construction of the transmission 10.

The transmission 10 according to the present embodiment is also configured such that the first and fourth clutches C1 and C4 have respective different diameters and are disposed outwardly and inwardly of each other such that the first and fourth clutches C1 and C4 at least partially overlap each other in the axial direction, as described above, so that the transmission 10 can be made compact in construction with a reduced axial dimension. Generally, a clutch has a smaller diametric dimension than a brake. A multiple-disk clutch of a frictional coupling type has a comparatively large axial dimension corresponding to the number of its friction plates. In this respect, the two clutches (first and fourth clutches) C1 and C4 disposed radially outwardly and inwardly of each other so as to at least partially overlap each other in the axial direction contribute to considerable reduction of the required axial dimension of the transmission 10.

The transmission 10 according to the present embodiment is further configured such that the second clutch C2 and the third clutch C3 are disposed between the second planetary gear set 20 and the third planetary gear set 24 in the axial direction, have respective different diameters, and are disposed radially outwardly and inwardly of each other such that the second and third clutches C2 and C3 at least partially overlap each other in the axial direction, like the first and fourth clutches C1, C4, as described above, so that the required axial dimension of the transmission 10 can be further reduced, and the transmission 10 can be made further compact in construction. Namely, the transmission 10 having the four clutches C1-C4 can be made compact in construction with considerable reduction of the required axial dimension owing to the partial axial overlapping arrangement of the two clutches (first and fourth clutches) C1 and C4 disposed outwardly and inwardly of each other, and the partial axial overlapping arrangement of the two clutches (second and third clutches) C2 and C3 disposed outwardly and inwardly of each other.

The transmission 10 according to the present embodiment is also configured such that the first brake B1 is disposed, together with the first and fourth clutches C1 and C4, on one of the opposite axial sides of the transmission 10, as described above, so that the transmission 10 can be made further compact in construction. In particular, the first brake B1 is disposed radially outwardly of the first clutch C1, so as to at least partially overlap the first clutch C1 in the axial direction, so that the transmission 10 can be made compact in construction with further reduction of the required axial dimension.

The transmission 10 according to the present embodiment is further configured to use the four planetary gear sets 18, 20, 24, 28 all of which are of the single-pinion type, as described above, so that the transmission 10 can be made compact in construction with a smaller diametric dimension, than where planetary gear sets of a double-pinion type are used.

The transmission 10 according to the present embodiment is also configured such that the nine forward drive speed positions “1st” through “9th” are selectively established by releasing actions of two selected ones of the six coupling elements (clutches C1-C4 and brakes B1 and B2) and engaging actions of the remaining four coupling elements. This indicates only two of the six coupling elements suffer from a dragging power loss, providing an improvement in the fuel economy of the vehicle.

Other embodiments of the present invention will be described next. It is to be understood that the same reference signs will be used to identify the same elements as described with respect to the first embodiment.

### Embodiment 2

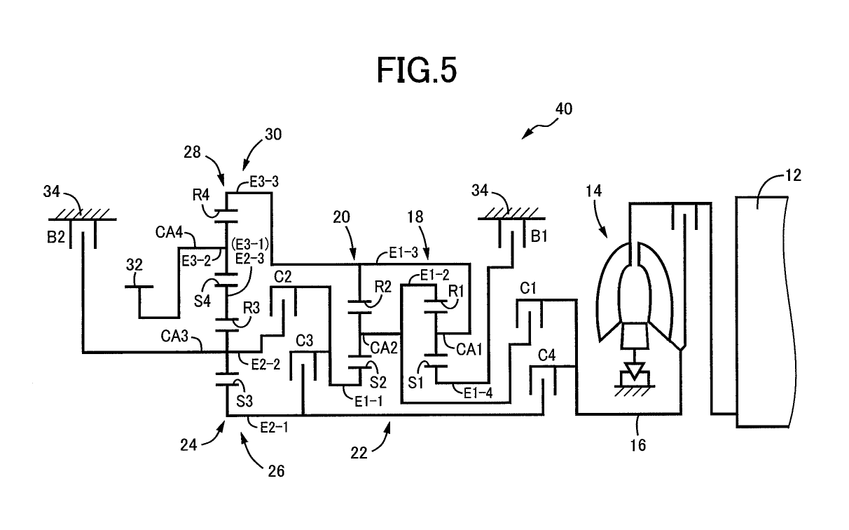

A transmission 40 according to a second embodiment shown in FIG. 5 is different from the transmission 10 of the first embodiment described above, only in that the fourth planetary gear set 28 is disposed radially outwardly of the third planetary gear set 24. Described more specifically, the sun gear S4 of the fourth planetary gear set 28 is disposed radially outwardly of the ring gear R3 of the third planetary gear set 24, so as to at least partially overlap the ring gear R3 in the axial direction, such that the sun gear S4 and the ring gear R3 are rotated together as a unit. The sun gear S4 and the ring gear R3 disposed radially outwardly and inwardly of each other contribute to further reduction of the required axial dimension of the transmission 40.

### Embodiment 3

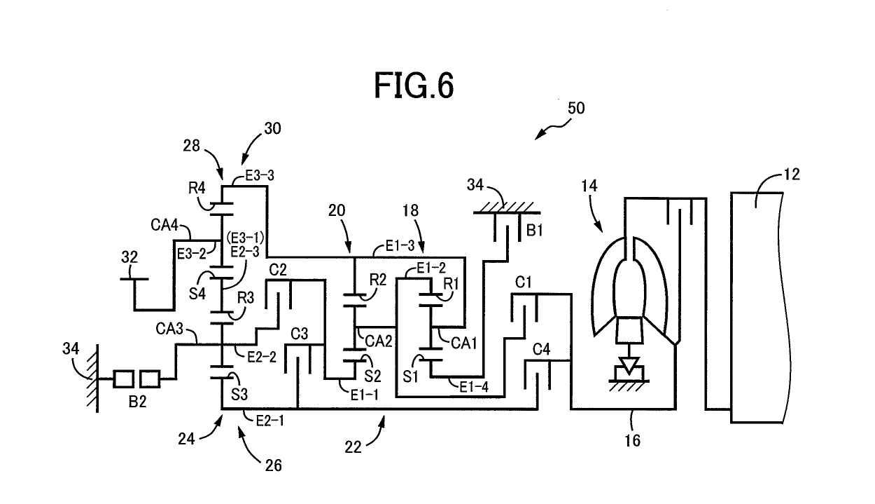

A transmission 50 according to a third embodiment shown in FIG. 6 is different from the transmission 40 of FIG. 5, in that the second brake B2 of the transmission 50 is constituted by a dog-type brake and is disposed radially inwardly of the output gear 32, so as to at least partially overlap the output gear 32 in the axial direction. As is apparent from the table of FIG. 2, the second brake B2 is engaged to establish the first speed position “1st” through the sixth speed position “6th”, and released to establish the seventh, eighth and ninth speed positions “7th”, “8th” and “9th”. That is, the second brake B2 is released for only shift-up actions of the transmission. In this respect, a meshing dog-type brake can be suitably used as the second brake B2. Namely, the dog-type brake is arranged to transmit power by a meshing action of teeth, and has a sufficient torque capacity with a relatively small diameter, so that the dog-type brake can be disposed compactly and radially inwardly of the output gear 32, so that the transmission 50 can be made compact with further reduction of the required axial dimension. Further, the dog-type brake is advantageously free from a dragging power loss in a released state, contributing to an improvement in the fuel economy of the vehicle. It is noted that the transmission 10 of FIG. 1 may employ the dog-type brake as the second brake B2, which is disposed radially inwardly of the output gear 32.

### Embodiment 4

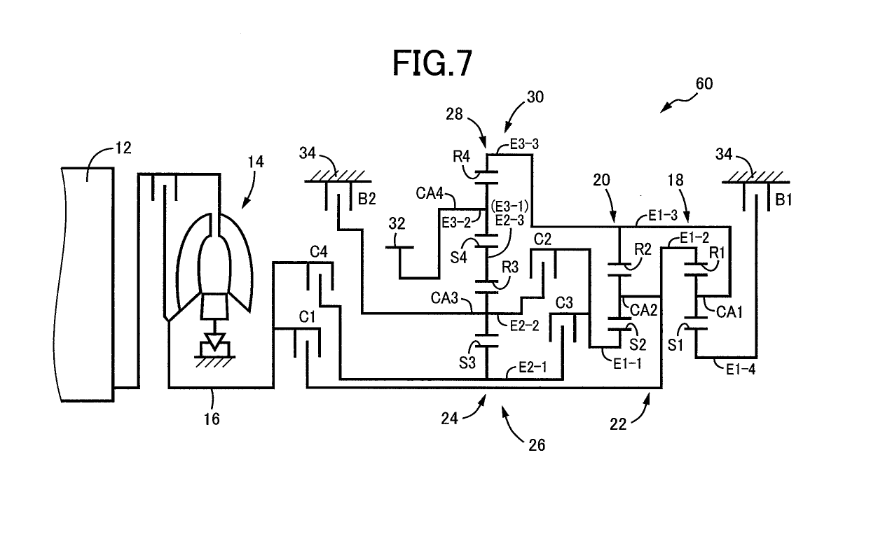

A transmission 60 according to a fourth embodiment shown in FIG. 7 is different from the transmission 50 of FIG. 5, in that the first and fourth clutches C1 and C4 functioning as the input clutches are disposed at the axial end portion of the transmission 60 on the side of the second brake B2, and in that the turbine shaft 16 functioning as the input rotary member, the engine 12 and the torque converter 14 are also disposed on the side of the second brake B2. Further, the fourth clutch C4 has a larger diameter than the first clutch C1, and is disposed radially outwardly of the first clutch C1, so as to at least partially overlap the first clutch C1 in the axial direction, while the second brake B2 has a larger diameter than the fourth clutch C4, and is disposed radially outwardly of the fourth clutch C4, so as to at least partially overlap the fourth clutch C4 in the axial direction. The transmission 60 of the fourth embodiment has substantially the same advantages as the transmission 50 of FIG. 5. The left end portion of the transmission 60 (as seen in FIG. 7) in which the torque converter 14 is disposed is referred to as one of the opposite axial sides of the transmission 60.

While the embodiments of this invention have been described above in detail by reference to the drawings, for illustrative purpose only, it is to be understood that the present invention may be embodied with various changes and improvements, which may occur to those skilled in the art.

### NOMENCLATURE OF ELEMENTS

| | |
|---|---|
| 10, 40, 50, 60: Transmission | 16: Turbine shaft (Input rotary member) |
| 18: First planetary gear set | 20: Second planetary gear set |
| 22: First transmission portion | 24: Third planetary gear set |
| 26: Second transmission portion | 28: Fourth planetary gear set |
| 30: Third transmission portion | 32: Output gear (Output rotary member) |
| C1: First clutch (Input clutch) | C2: Second clutch |
| C3: Third clutch | C4: Fourth clutch (Input clutch) |
| B1: First brake | B2: Second brake |
| E1-1: 1-1 Rotary element | E1-2: 1-2 rotary element |
| E1-3: 1-3 rotary element | E1-4: 1-4 rotary element |
| E2-1: 2-1 rotary element | E2-2: 2-2 rotary element |
| E2-3: 2-3 rotary element | E3-1: 3-1 rotary element |
| E3-2: 3-2 rotary element | E3-3: 3-3 rotary element |

What is claimed is:

1. A transmission comprising at least four planetary gear sets and at least six coupling elements which are all disposed coaxially with each other, and an input rotary member which is disposed on one of opposite axial sides of the transmission and which receives an input rotary motion, the transmission having a plurality of speed positions which have respective different speed ratios and which are established by engaging actions of respective combinations of coupling elements selected from said at least six coupling elements and releasing actions of respective combinations of the other coupling elements selected from said at least six coupling elements, wherein an improvement comprises:
said at least six coupling elements including at least two input clutches which are all connected to said input rotary member and which are all disposed on one of opposite axial sides of said at least four planetary gear sets, which one side corresponds to said one of the opposite axial sides of the transmission.

2. The transmission according to claim 1, wherein said at least six coupling elements include at least one brake which is disposed, together with said at least two input clutches, on said one of the opposite axial sides of said at least four planetary gear sets.

3. The transmission according to claim 1, wherein said at least two input clutches have respective different diameters and are disposed radially outwardly and inwardly of each other so as to at least partially overlap each other in an axial direction.

4. A transmission comprising at least four planetary gear sets and at least six coupling elements which are all disposed coaxially with each other, and an input rotary member which is disposed on one of opposite axial sides of the transmission and which receives an input rotary motion, the transmission having a plurality of speed positions which have respective different speed ratios and which are established by engaging actions of respective combinations of coupling elements selected from said at least six coupling elements and releasing actions of respective combinations of the other coupling elements selected from said at least six coupling elements, wherein an improvement comprises:
said at least six coupling elements including at least four clutches which are spaced from said planetary gear sets in an axial direction of the transmission; and
said at least four clutches including at least two sets of clutches each set consisting of at least two clutches which have respective different diameters and which are disposed radially outwardly and inwardly of each other so as to at least partially overlap each other in the axial direction.

5. The transmission according to claim 1, wherein said at least four planetary gear sets are all of a single-pinion type, and include two planetary gear sets which respectively have a ring gear and a sun gear disposed radially outwardly of said ring gear such that the ring gear and the sun gear at least partially overlap each other in an axial direction and such that the ring gear and the sun gear are rotated together as a unit.

6. The transmission according to claim 4, wherein said at least four planetary gear sets are all of a single-pinion type, and include two planetary gear sets which respectively have a ring gear and a sun gear disposed radially outwardly of said ring gear such that the ring gear and the sun gear at least partially overlap each other in an axial direction and such that the ring gear and the sun gear are rotated together as a unit.

7. The transmission according to claim 1, further comprising an output gear as an output rotary member, and wherein said at least six coupling elements include at least one dog-type coupling element which is released for only shift-up actions of the transmission, at least one of said at least one dog-type coupling element being disposed radially inwardly of said output gear, so as to at least partially overlap the output gear in the axial direction.

8. The transmission according to claim 4, further comprising an output gear as an output rotary member, and wherein said at least six coupling elements include at least one dog-type coupling element which is released for only shift-up actions of the transmission, at least one of said at least one dog-type coupling element being disposed radially inwardly of said output gear, so as to at least partially overlap the output gear in the axial direction.

9. The transmission according to claim 1, wherein said plurality of speed positions are established by releasing actions of respective combinations of two coupling elements selected from said at least six coupling elements and engaging actions of respective combinations of the remaining coupling elements.

10. The transmission according to claim 4, wherein said plurality of speed positions are established by releasing actions of respective combinations of two coupling elements selected from said at least six coupling elements and engaging actions of respective combinations of the remaining coupling elements.

11. The transmission according to claim 1, wherein said plurality of speed positions consist of at least nine speed positions.

12. The transmission according to claim 4, wherein said plurality of speed positions consist of at least nine speed positions.

13. A transmission comprising four planetary gear sets and six coupling elements which are all disposed coaxially with each other, and an input rotary member which receives an input rotary motion, the transmission having a plurality of speed positions which have respective different speed ratios and which are established by engaging actions of respective combinations of coupling elements selected from said six coupling elements and releasing actions of respective combinations of the other coupling elements selected from said six coupling elements, wherein an improvement comprises:
said four planetary gear sets consisting of a first planetary gear set, a second planetary gear set, a third planetary gear set and a fourth planetary gear set, while said six coupling elements consist of a first clutch, a second clutch, a third clutch, a fourth clutch, a first brake and a second brake;
said first planetary gear set and said second planetary gear set constituting a first transmission portion wherein the first and second planetary gear sets are connected to each other so as to provide four rotary elements consisting of a 1-1 rotary element, a 1-2 rotary element, a 1-3 rotary element and a 1-4 rotary element which are arranged in this order of description as seen in a collinear chart from one end toward the other end of one part of the collinear chart, and the 1-2 rotary element is selectively connected to said input rotary member through said first clutch, while the 1-4 rotary element is selectively held stationary by said first brake;
said third planetary gear set constituting a second transmission portion including three rotary elements consisting of a 2-1 rotary element, a 2-2 rotary element and a 2-3 rotary element which are arranged in this order of description as seen in a collinear chart from one end toward the other end of another part of the collinear chart, and wherein the 2-1 rotary element is selectively connected to said input rotary member through said fourth clutch, and the 2-2 rotary element is selectively held stationary by said second brake;
the 1-1 rotary element of said first transmission portion being selectively connected to the 2-2 rotary element of said second transmission portion through said second clutch and to the 2-1 rotary element of the second transmission portion through said third clutch; and
said fourth planetary gear set constituting a third transmission portion including three rotary elements consisting of a 3-1 rotary element, a 3-2 rotary element and a 3-3 rotary element which are arranged in this order of description as seen in the collinear chart from one end toward the other end of a collinear chart, and wherein the 3-1 rotary element is fixed to the 2-3 rotary element of said second transmission portion, and the 3-3 rotary element is fixed to the 1-3 rotary element of said first transmission portion, while the 3-2 rotary element is fixed to an output rotary member.

14. The transmission according to claim 13, wherein said first, second, third and fourth planetary gear sets are all of a single-pinion type.

15. The transmission according to claim 14, wherein said first planetary gear set of said first transmission portion is a planetary gear set of a single-pinion type having a sun gear S1, a carrier CA1 and a ring gear R1, and said second planetary gear set of the first transmission portion is a planetary gear set of a single-pinion type having a sun gear S2, a carrier CA2 and a ring gear R2, the sun gear S2 constituting said 1-1 rotary element, the ring gear R1 and the carrier CA2 are fixed to each other to constitute said 1-2 rotary element, the carrier CA1 and the ring gear R2 are fixed to each other to constitute said 1-3 rotary element, and the sun gear S1 constituting said 1-4 rotary element,
said third planetary gear set of said second transmission portion is a planetary gear set of a single-pinion type having, as said three rotary elements, a sun gear S3, a carrier CA3 and a ring gear R3, the sun gear S3 constituting said 2-1 rotary element, the carrier CA3 constituting said 2-2 rotary element, and the ring gear R3 constituting said 2-3 rotary element,
said fourth planetary gear set of said third transmission portion is a planetary gear set of a single-pinion type having, as said three rotary elements, a sun gear S4, a carrier CA4 and a ring gear R4, the sun gear S4 constituting said 3-1 rotary element, the carrier CA4 constituting said 3-2 rotary element, and the ring gear R4 constituting said 3-3 rotary element.

16. A transmission comprising four planetary gear sets and six coupling elements which are all disposed coaxially with each other, and an input rotary member which receives an input rotary motion, the transmission having a plurality of speed positions which have respective different speed ratios and which are established by engaging actions of respective combinations of coupling elements selected from said six coupling elements and releasing actions of respective combinations of the other coupling elements selected from said six coupling elements, wherein an improvement comprises:
said four planetary gear sets consisting of a first planetary gear set, a second planetary gear set, a third planetary gear set and a fourth planetary gear set, while said six coupling elements consisting of a first clutch, a second clutch, a third clutch, a fourth clutch, a first brake and a second brake;
said first planetary gear set being a planetary gear set of a single-pinion type having a sun gear S1, a carrier CA1 and a ring gear R1, and said second planetary gear set is a planetary gear set of a single-pinion type having a sun gear S2, a carrier CA2 and a ring gear R2, the first and second planetary gear sets constituting a first transmission portion wherein the sun gear S2 constitutes a 1-1 rotary element, the ring gear R1 and the carrier CA2 are fixed to each other to constitute a 1-2 rotary element, the carrier CA1 and the ring gear R2 are fixed to each other to constitute a 1-3 rotary element, and the sun gear S1 constitutes a 1-4 rotary element, the 1-2 rotary element being selectively connected to said input rotary member through said first clutch, while the 1-4 rotary element is selectively held stationary by said first brake;
said third planetary gear set being a planetary gear set of a single-pinion type which has a sun gear S3, a carrier CA3 and a ring gear R3 and which constitutes a second transmission portion wherein the sun gear S3 constitutes a 2-1 rotary element, the carrier CA3 constitutes a 2-2 rotary element, and the ring gear R3 constitutes a 2-3 rotary element, the 2-1 rotary element being selectively connected to said input rotary member through said fourth clutch, and the 2-2 rotary element being selectively held stationary by said second brake;
the 1-1 rotary element of said first transmission portion being selectively connected to the 2-2 rotary element of said second transmission portion through said second clutch and to the 2-1 rotary element of the second transmission portion through said third clutch; and
said fourth planetary gear set being a planetary gear set of a single-pinion type which has a sun gear S4, a carrier CA4 and a ring gear R4 and which constitutes a third transmission portion wherein the sun gear S4 constitutes a 3-1 rotary element, the carrier CA4 constitutes a 3-2 rotary element, and the ring gear R4 constitutes a 3-3 rotary element, the 3-1 rotary element being fixed to the 2-3 rotary element of said second transmission portion, and the 3-3 rotary element is fixed to the 1-3 rotary element of said first transmission portion, while the 3-2 rotary element is fixed to an output rotary member.

17. The transmission according to claim 13, wherein said input rotary member is disposed on one of opposite axial sides of said four planetary gear sets, and said first clutch and said fourth clutch are disposed on said one of the opposite axial sides of said four planetary gear sets and are connected to said input rotary member, said first and fourth clutches having respective different diameters and being disposed radially outwardly and inwardly of each other, so as to at least partially overlap each other in an axial direction.

18. The transmission according to claim 16, wherein said input rotary member is disposed on one of opposite axial sides of said four planetary gear sets, and said first clutch and said fourth clutch are disposed on said one of the opposite axial sides of said four planetary gear sets and are connected to said input rotary member, said first and fourth clutches having respective different diameters and being disposed radially outwardly and inwardly of each other, so as to at least partially overlap each other in an axial direction.

19. The transmission according to claim 13, wherein said first, second and third planetary gear sets are arranged in the axial direction in this order of description, and said second and third clutches have respective different diameters and are disposed between said second and third planetary gear sets in the axial direction, and radially outwardly and inwardly of each other, so as to at least partially overlap each other in the axial direction.

20. The transmission according to claim 16, wherein said first, second and third planetary gear sets are arranged in the axial direction in this order of description, and said second and third clutches have respective different diameters and are disposed between said second and third planetary gear sets in the axial direction, and radially outwardly and inwardly of each other, so as to at least partially overlap each other in the axial direction.

21. The transmission according to claim 13, wherein said fourth planetary gear set is disposed radially outwardly of said third planetary gear set, so as to at least partially overlap each other in the axial direction, such that the sun gear S4 of the fourth planetary gear set is disposed radially outwardly of the ring gear R3 of the third planetary gear set and such that said sun gear S4 and said ring gear R3 are rotated together as a unit.

22. The transmission according to claim 16, wherein said fourth planetary gear set is disposed radially outwardly of said third planetary gear set, so as to at least partially overlap each other in the axial direction, such that the sun gear S4 of the fourth planetary gear set is disposed radially outwardly of the ring gear R3 of the third planetary gear set and such that said sun gear S4 and said ring gear R3 are rotated together as a unit.

23. The transmission according to claim 13, further comprising an output gear as an output rotary member, and wherein said second brake is a dog-type brake disposed radially inwardly of said output gear, so as to at least partially overlap the output gear in the axial direction.

24. The transmission according to claim 16, further comprising an output gear as an output rotary member, and wherein said second brake is a dog-type brake disposed radially inwardly of said output gear, so as to at least partially overlap the output gear in the axial direction.

25. The transmission according to claim 13, wherein said plurality of speed positions consist of at least nine speed positions which are established by releasing actions of respective combinations of two coupling elements selected from said six coupling elements and engaging actions of respective combinations of the remaining four coupling elements.

26. The transmission according to claim 16, wherein said plurality of speed positions consist of at least nine speed positions which are established by releasing actions of respective combinations of two coupling elements selected from said six coupling elements and engaging actions of respective combinations of the remaining four coupling elements.

27. The transmission according to claim 25, wherein said at least nine speed positions consist of a first speed position having a highest speed ratio, a second speed position having a speed ratio lower than that of the first speed position, a third speed position having a speed ratio lower than that of the second speed position, a fourth speed position having a speed ratio lower than that of the third speed position, a fifth speed position having a speed ratio lower than that of the fourth speed position, a sixth speed position having a speed ratio lower than that of the fifth speed position, a seventh speed position having a speed ratio lower than that of the sixth speed position, an eighth speed position having a speed ratio lower than that of the seventh speed position, and a ninth speed position having a speed ratio lower than that of the eighth speed position,
said first speed position being established by engaging actions of said third and fourth clutches and said first and second brakes, and releasing actions of said first and second clutches,
said second speed position being established by engaging actions of said first and third clutches and said first and second brakes and releasing actions of said second and fourth clutches,
said third speed position being established by engaging actions of said first and fourth clutches and said first and second brakes and releasing actions of said second and third clutches,
said fourth speed position being established by engaging actions of said first, third and fourth clutches and said second brake and releasing actions of said second clutch and said first brake,
said fifth speed position being established by engaging actions of said first, second and fourth clutches and said second brake and releasing actions of said third clutch and said first brake,
said sixth speed position being established by engaging actions of said first, second and third clutches and said second brake and releasing actions of said fourth clutch and said first brake,
said seventh speed position being established by engaging actions of said first, second, third and fourth clutches and releasing actions of said first and second brakes,
said eighth speed position being established by engaging actions of said first, second and third clutches and said first brake and releasing actions of said fourth clutch and said second brake, and
said ninth speed position being established by engaging actions of said first, second and fourth clutches and said first brake and releasing actions of said third clutch and said second brake.

28. The transmission according to claim 26, wherein said at least nine speed positions consist of a first speed position having a highest speed ratio, a second speed position having a speed ratio lower than that of the first speed position, a third speed position having a speed ratio lower than that of the second speed position, a fourth speed position having a speed ratio lower than that of the third speed position, a fifth speed position having a speed ratio lower than that of the fourth speed position, a sixth speed position having a speed ratio lower than that of the fifth speed position, a seventh speed position having a speed ratio lower than that of the sixth speed position, an eighth speed position having a speed ratio lower than that of the seventh speed position, and a ninth speed position having a speed ratio lower than that of the eighth speed position,
said first speed position being established by engaging actions of said third and fourth clutches and said first and second brakes, and releasing actions of said first and second clutches,
said second speed position being established by engaging actions of said first and third clutches and said first and second brakes and releasing actions of said second and fourth clutches,
said third speed position being established by engaging actions of said first and fourth clutches and said first and second brakes and releasing actions of said second and third clutches,
said fourth speed position being established by engaging actions of said first, third and fourth clutches and said second brake and releasing actions of said second clutch and said first brake,
said fifth speed position being established by engaging actions of said first, second and fourth clutches and said second brake and releasing actions of said third clutch and said first brake,
said sixth speed position being established by engaging actions of said first, second and third clutches and said second brake and releasing actions of said fourth clutch and said first brake,
said seventh speed position being established by engaging actions of said first, second, third and fourth clutches and releasing actions of said first and second brakes,
said eighth speed position being established by engaging actions of said first, second and third clutches and said first brake and releasing actions of said fourth clutch and said second brake, and
said ninth speed position being established by engaging actions of said first, second and fourth clutches and said first brake and releasing actions of said third clutch and said second brake.
